(19) United States
(12) Patent Application Publication
(10) Pub. No.: US 2025/0390356 A1
(43) Pub. Date: Dec. 25, 2025

(54) OPTIMIZATION OF RESOURCE ALLOCATION AMONGST MULTIPLE RESOURCE CONSUMERS

(71) Applicant: Dell Products L.P., Round Rock, TX (US)

(72) Inventors: Nushafreen Dara Palsetia, Mumbai (IN); Samyuktha Srinivasan, Bangalore (IN); Nandita Gurunathan, Puducherry (IN)

(21) Appl. No.: 18/749,363

(22) Filed: Jun. 20, 2024

(51) Int. Cl. G06F 9/50

(52) U.S. Cl. CPC G06F 9/505

(57) ABSTRACT

A method for resource allocation optimization. The method includes: selecting a resource type from resources on a host system; computing, based on the resource type, a plurality of weights including a weight for each resource consumer of a plurality of resource consumers on the host system; computing, of the resource type, a total resource usage based on the plurality of weights and a division of available resource type units; making a determination that the total resource usage equals one; and allocating, based on the determination, a number of available resource type units of the resource type amongst the plurality of resource consumers.

### BACKGROUND

In a computing environment where multiple instances of a resource are available, there is a requirement to distribute these resources among the requesting entities. Existing methods divide total available resources among requesting entities without considering minimization of overall resource usage.

### SUMMARY

In general, in one aspect, embodiments described herein relate to a method for resource allocation optimization. The method includes: selecting a resource type from resources on a host system; computing, based on the resource type, a plurality of weights including a weight for each resource consumer of a plurality of resource consumers on the host system; computing, of the resource type, a total resource usage based on the plurality of weights and a division of available resource type units; making a determination that the total resource usage equals one; and allocating, based on the determination, a number of available resource type units of the resource type amongst the plurality of resource consumers.

In general, in one aspect, embodiments described herein relate to a non-transitory computer readable medium (CRM). The non-transitory CRM includes computer readable program code, which when executed by at least one computer processor, enables the at least one computer processor to perform a method for resource allocation optimization. The method includes: selecting a resource type from resources on a host system; computing, based on the resource type, a plurality of weights including a weight for each resource consumer of a plurality of resource consumers on the host system; computing, of the resource type, a total resource usage based on the plurality of weights and a division of available resource type units; making a determination that the total resource usage equals one; and allocating, based on the determination, a number of available resource type units of the resource type amongst the plurality of resource consumers.

In general, in one aspect, embodiments described herein relate to a host system. The host system includes: resources including compute resources, the compute resources including at least one computer processor; a resource allocator operatively connected to the resources and executing on the at least one computer processor; and a plurality of resource consumers operatively connected to the resource allocator and also executing on the at least one computer processor, wherein the resource allocator is configured to perform a method for resource allocation optimization. The method includes: selecting a resource type from the resources; computing, based on the resource type, a plurality of weights including a weight for each resource consumer of the plurality of resource consumers; computing, of the resource type, a total resource usage based on the plurality of weights and a division of available resource type units; making a determination that the total resource usage equals one; and allocating, based on the determination, a number of available resource type units of the resource type amongst the plurality of resource consumers.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1 shows a computing device in accordance with one or more embodiments described herein.

FIG. 2 shows a computing device in accordance with one or more embodiments described herein.

FIG. 3 shows a computing device in accordance with one or more embodiments described herein.

FIG. 4 shows a computing device in accordance with one or more embodiments described herein.

FIG. 5 shows a hyper-converged infrastructure cluster in accordance with one or more embodiments described herein.

FIG. 6A shows a flowchart outlining a method for determining whether to optimize resource allocation amongst multiple resource consumers in accordance with one or more embodiments described herein.

FIGS. 6B and 6C show a flowchart outlining a method for optimizing resource allocation amongst multiple resource consumers in accordance with one or more embodiments described herein.

FIG. 7 shows a computing system in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to the optimization of resource allocation amongst multiple resource consumers. Particularly, in a computing environment where multiple instances of a resource are available, there is a requirement to distribute these resources among the requesting entities (also referred to herein as resource consumers). Existing methods divide total available resources among requesting entities without considering minimization of overall resource usage.

Unlike said existing methods, embodiments described herein: dynamically distribute and allocate resources based on the relative requirements of the parallel requesting entities optimized to minimize overall resource usage by these entities; and determine the least upper bound of the total resources that need to be carved out for these entities from the available resources. Administrators and/or customers of any environment (e.g., computing device, hyper-converged infrastructure cluster, etc.) may utilize any determined least upper bound to ascertain a sizing of said environment and whether said sizing meets any service-level agreement (SLA) requirements prior to deployment of said environment. The sizing of an environment refers to the estimation of resources needed by resource consumers such that an over- and/or under-subscription of said resources is/are avoided, where said avoidance prevents resource wastage, thereby ensuring reduced power utilization and improved cost savings.

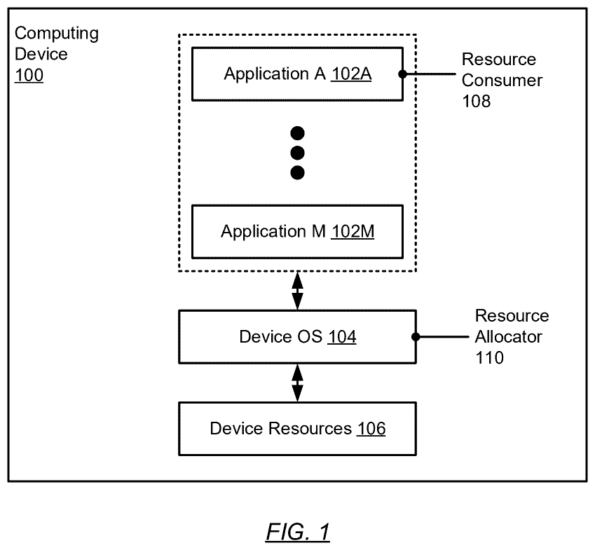

FIG. 1 shows a computing device in accordance with one or more embodiments described herein. The computing device (100) may represent a physical appliance at least configured to receive, generate, process, store, and/or transmit data, as well as provide an environment in which one or many workload(s) (not shown) (described below) may be performed thereon. One of ordinary skill, however, will appreciate that the computing device (100) may perform other functionalities without departing from the scope of the embodiments described herein.

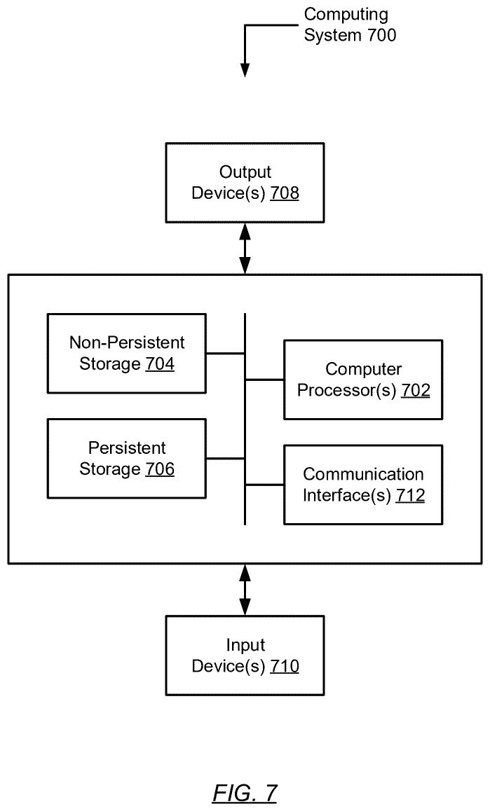

Examples of the computing device (100) may include, but are not limited to, a desktop computer, a laptop computer, a network server, a smartphone, a tablet computer, or any computing system similar to the exemplary computing system illustrated and described with respect to FIG. 7, below.

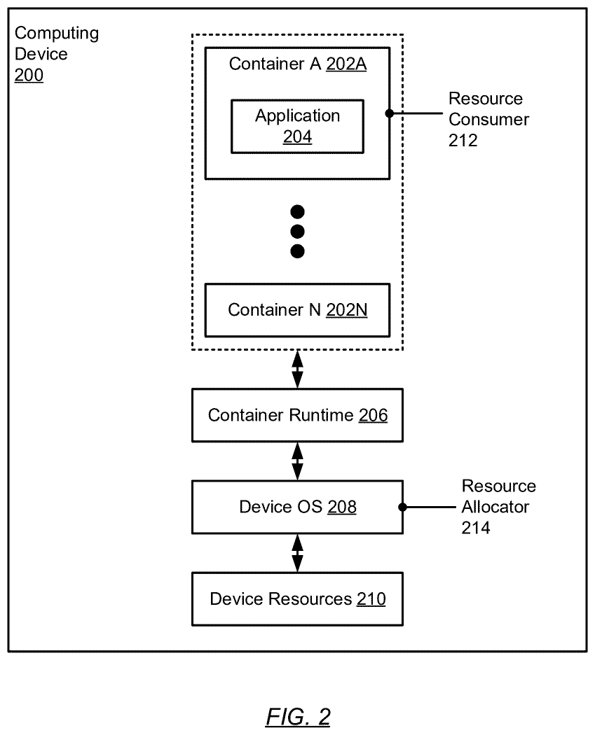

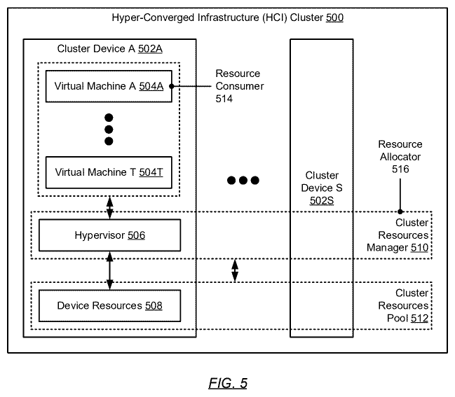

In one or many embodiment(s) described herein, any workload may refer to the utilization of resources to effect work within a computing environment (e.g., computing device (100) (also see e.g., FIGS. 2-4), hyper-converged infrastructure (HCI) cluster (see e.g., FIG. 5), etc.). Examples of any workload may include services offered locally and/or over networks, computational tasks/functions, data transactions, database management, content management systems, media streaming, online gaming, machine learning and/or artificial intelligence based processing, financial modeling, and automation. Further, any workload is not limited to the aforementioned specific examples.

In one or many embodiment(s) described herein, the computing device (100) may include one or more applications (102A-102M), a device operating system (OS) (104), and device resources (106). Each of these computing device (100) components is described below.

In one or many embodiment(s) described herein, any application (102A-102M) (also referred to herein as a software application) may refer to a computer program, or computer readable instructions, which when executed or invoked, performs one or more tasks directed to a specific purpose. To said extent, and at least in part, any application (102A-102M) may include functionality to: request access to any granularity of the device resources (106) via any number of system calls submitted to the device OS (104); and consume said any granularity of the device resources (106) allocated thereto towards achieving said task(s). One of ordinary skill, however, will appreciate that any application (102A-102M) may perform other functionalities without departing from the scope of the embodiments described herein.

In one or many embodiment(s) described herein, any application (102A-102M) may operate as a resource consumer (108). Within any computing environment, any resource consumer (108), in turn, may generally refer to a logical entity, executing thereon, capable of requesting and consuming/using at least a subset of any number, as well as any variety, of the physical resources available through the computing environment. Further, said physical resources (e.g., device resources (106)) may be requested and consumed by any resource consumer (108) in the form of resource type units appropriate to the resource type.

In one or many embodiment(s) described herein, the device OS (104) may refer to a computer program, or computer readable instructions, which when executed or invoked, perform one or more tasks responsible for overseeing computing device (100) operations. To said extent, and at least in part, the device OS (104) may include functionality to: schedule fundamental computing device (100) functions; mediate interactivity between any logical (e.g., application(s) (102A-102M)) and any physical (e.g., device resources (106)) components of the computing device (100); allocate and/or de-allocate any granularity of the device resources (106) as needed to service any number of received system calls; and execute or invoke other computer program(s) and/or computer readable instructions. One of ordinary skill, however, will appreciate that the device OS (104) may perform other functionalities without departing from the scope of the embodiments described herein.

In one or many embodiment(s) described herein, the device OS (104) may operate as a resource allocator (110). Within any computing environment, any resource allocator (110), in turn, may generally refer to a logical entity, executing thereon, capable of allocating and de-allocating at least a subset of any number, as well as any variety, of the physical resources available through the computing environment. Further, said physical resources (e.g., device resources (106)) may be allocated to and de-allocated from any resource consumer (108) in the form of resource type units appropriate to the resource type.

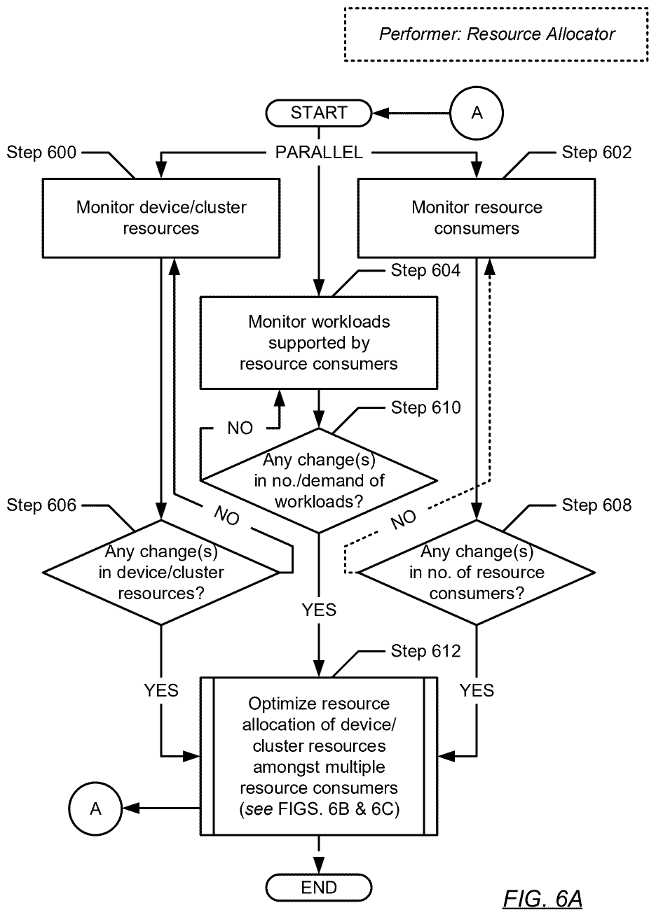

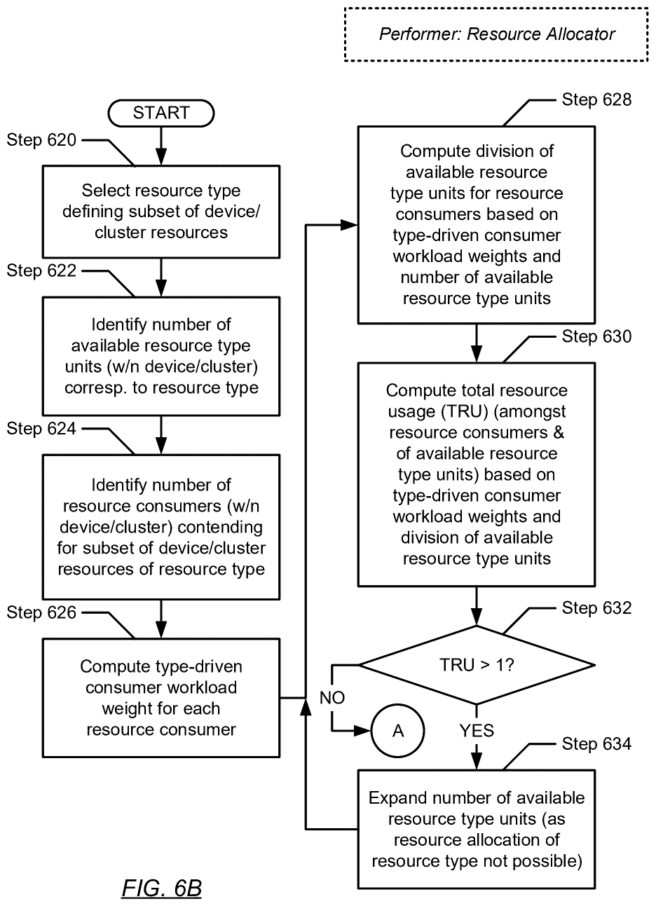

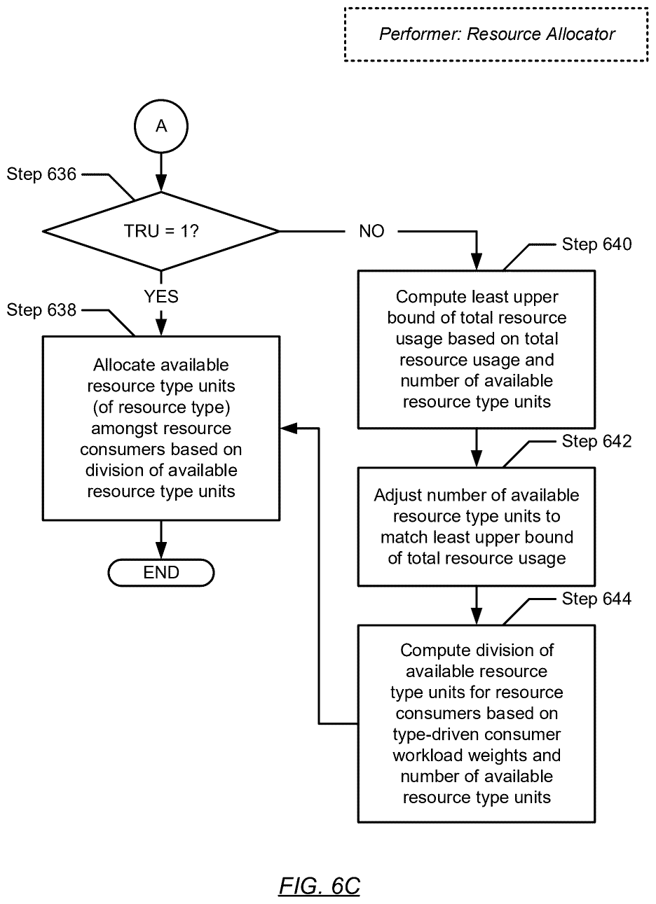

In one or many embodiment(s) described herein, any resource allocator (110) may include functionality to: determine whether to optimize resource allocation amongst multiple resource consumers (108) as illustrated and described with respect to FIG. 6A, below; and optimize resource allocation amongst multiple resource consumers (108) as illustrated and described with respect to FIGS. 6B and 6C, below.

In one or many embodiment(s) described herein, the device resources (106) may refer to any number of physical resources natively available to, or physically installed on, the computing device (100). Further, said physical resources may be segmented into various resource types each defining a subset of the device resources (106). Said various resource types may include compute resources (not shown), memory resources (not shown), storage resources (not shown), networking resources (not shown), and accelerated compute resources (not shown). Each of these resource types is described below.

In one or many embodiment(s) described herein, the compute resources may refer to any number of integrated circuits configured for computer readable instructions processing. Said integrated circuits may include central processing units (CPUs) (also referred to herein as computer processors). Further, allocation of any compute resources, which may be requested and consumed, may be measured in the form of one or more processor cores.

In one or many embodiment(s) described herein, the memory resources may refer to any number of integrated circuits configured for short-term and/or long-term storage of data and computer readable instructions that may be quickly accessed by the compute and/or accelerated compute resources. Said integrated circuits may include volatile memory (e.g., random access memory (RAM)) and non-volatile memory (e.g., read only memory (ROM)). Further, allocation of any memory resources, which may be requested and consumed, may be measured in the form of one or more memory bytes.

In one or many embodiment(s) described herein, the storage resources may refer to any number of non-transitory computer readable storage mediums configured for the storage of various forms of computer readable information (e.g., structured and/or unstructured data) in whole or in part, and temporarily or permanently. Said non-transitory computer readable storage mediums may include optical storage (e.g., compact discs (CDs) and digital versatile discs (DVDs), magnetic storage (e.g., magnetic tapes, floppy disks, and hard disk drives (HDDs)), and solid-state storage (e.g., solid-state drives (SSDs), thumb drives, and secure digital (SD) cards). Further, allocation of any storage resources, which may be requested and consumed, may be measured in the form of one or more storage bytes.

In one or many embodiment(s) described herein, the networking resources may refer to any number of integrated circuits configured for data transmission and reception over any number of networks (e.g., local area networks (LANs), wide area networks (WANs) such as the Internet, mobile networks, etc.). Said integrated circuits may include network adapters and network interface cards (NICs). Further, allocation of any networking resources, which may be requested and consumed, may be measured in the form of one or more bits per second (bps).

In one or many embodiment(s) described herein, the accelerated compute resources may refer to any number of integrated circuits configured for speeding up demanding workloads through the use of parallel processing. Said integrated circuits may include graphics processing units (GPUs), data processing units (DPUs), tensor processing units (TPUs), and vision processing units (VPUs) —also collectively referred to herein as accelerated processors. Further, allocation of any accelerated compute resources, which may be requested and consumed, may be measured in the form of one or more accelerated cores.

While FIG. 1 shows a configuration of components and/or subcomponents, other computing device (100) configurations may be used without departing from the scope of the embodiments described herein.

For example, in one or many embodiment(s) described herein, alternate computing device configurations may resemble those illustrated and described below with respect to FIGS. 2-4.

By way of another example, in one or many embodiment(s) described herein, any alternate computing device configuration(s) may reflect a combination of the above-described computing device (100) with one or more of the subsequent computing device(s) illustrated and described below with respect to FIGS. 2-4.

FIG. 2 shows a computing device in accordance with one or more embodiments described herein. The computing device (200) may represent a physical appliance at least configured to receive, generate, process, store, and/or transmit data, as well as provide an environment in which one or many workload(s) (not shown) (described above—see e.g., FIG. 1) may be performed thereon. One of ordinary skill, however, will appreciate that the computing device (200) may perform other functionalities without departing from the scope of the embodiments described herein.

Examples of the computing device (200) may include, but are not limited to, a desktop computer, a laptop computer, a network server, a smartphone, a tablet computer, or any computing system similar to the exemplary computing system illustrated and described with respect to FIG. 7, below.

In one or many embodiment(s) described herein, the computing device (200) may include one or more containers (202A-202N), a container runtime (206), a device OS (208), and device resources (210). Each of these computing device (200) components is described below.

In one or many embodiment(s) described herein, any container (202A-202N) may refer to a computer program, or computer readable instructions, which when executed or invoked, implements a standalone, lightweight virtualization environment. Said virtualization environment, further, may support the quick and reliable execution of an application (204) (described above—see e.g., FIG. 1) therein and over any hardware infrastructure and/or OS. To said extent, and at least in part, any container (202A-202N) may include any dependencies (e.g., computer readable program code, runtime, system tools, libraries, configuration settings, etc.) required by the application (204) to execute properly. One of ordinary skill, however, will appreciate that any container (202A-202N) may perform other functionalities without departing from the scope of the embodiments described herein.

In one or many embodiment(s) described herein, any container (202A-202N) may operate as a resource consumer (212) (described above—see e.g., FIG. 1).

In one or many embodiment(s) described herein, the container runtime (206) may refer to a computer program, or computer readable instructions, which when executed or invoked, enables any container(s) (202A-202N) to operate within a host system (e.g., computing device (200)). To said extent, and at least in part, the container runtime (206) may include functionality to manage the lifecycle of any container(s) (202A-202N), including: creating said container(s) (202A-202N) and initiating their environment based on a container image including an application (204) and its dependencies; executing said container(s) (202A-202N), as well as the application (204), and ensuring their proper function; monitoring the health of said container(s) (202A-202N); restarting said container(s) (202A-202N) should they fail; and deactivating and deleting said container(s) (202A-202N) when no longer in use. One of ordinary skill, however, will appreciate that the container runtime (206) may perform other functionalities without departing from the scope of the embodiments described herein.

In one or many embodiment(s) described herein, the device OS (208) may refer to a computer program, or computer readable instructions, which when executed or invoked, performs one or more tasks responsible for overseeing computing device (200) operations. To said extent, and at least in part, the device OS (208) may include functionality to: schedule fundamental computing device (200) functions; mediate interactivity between any logical (e.g., container(s) (202A-202N)) and any physical (e.g., device resources (210)) components of the computing device (200); allocate and/or de-allocate any granularity of the device resources (210) as needed to service any number of received system calls; and execute or invoke other computer program(s) and/or computer readable instructions. One of ordinary skill, however, will appreciate that the device OS (208) may perform other functionalities without departing from the scope of the embodiments described herein.

In one or many embodiment(s) described herein, the device OS (208) may operate as a resource allocator (214) (described above—see e.g., FIG. 1). Further, any resource allocator (214) may include functionality to: determine whether to optimize resource allocation amongst multiple resource consumers (212) as illustrated and described with respect to FIG. 6A, below; and optimize resource allocation amongst multiple resource consumers (212) as illustrated and described with respect to FIGS. 6B and 6C, below.

In one or many embodiment(s) described herein, the device resources (210) may refer to any number of physical resources natively available to, or physically installed on, the computing device (200). Further, said physical resources may be segmented into various resource types each defining a subset of the device resources (210). Said various resource types may include compute resources (not shown), memory resources (not shown), storage resources (not shown), networking resources (not shown), and accelerated compute resources (not shown) (all described above—see e.g., FIG. 1).

While FIG. 2 shows a configuration of components and/or subcomponents, other computing device (200) configurations may be used without departing from the scope of the embodiments described herein.

For example, in one or many embodiment(s) described herein, alternate computing device configurations may resemble those illustrated and described above and below with respect to FIGS. 1, 3, and 4.

By way of another example, in one or many embodiment(s) described herein, any alternate computing device configuration(s) may reflect a combination of the above-described computing device (200) with one or more of the previous or subsequent computing device(s) illustrated and described above or below with respect to FIGS. 1, 3, and 4.

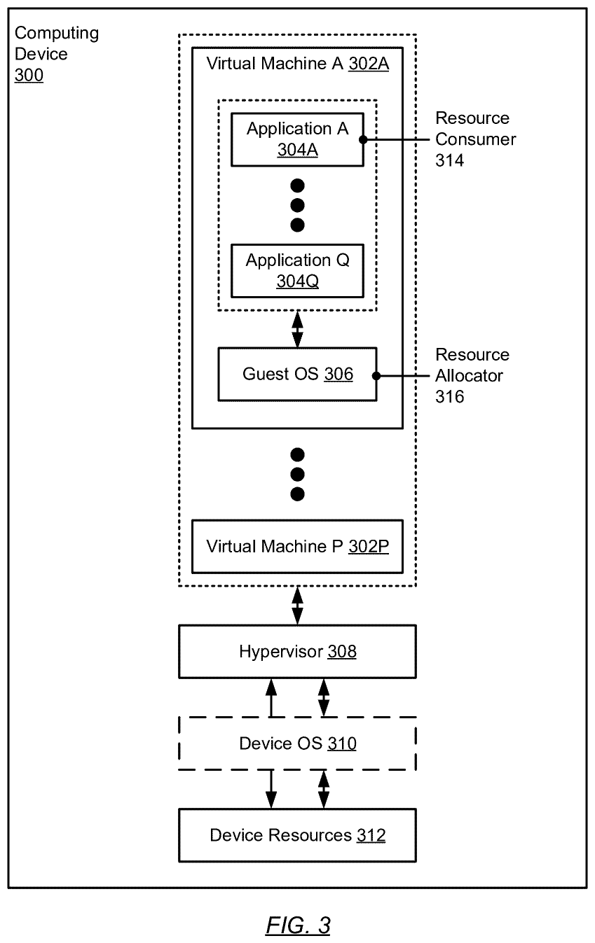

FIG. 3 shows a computing device in accordance with one or more embodiments described herein. The computing device (300) may represent a physical appliance at least configured to receive, generate, process, store, and/or transmit data, as well as provide an environment in which one or many workload(s) (not shown) (described above—see e.g., FIG. 1) may be performed thereon. One of ordinary skill, however, will appreciate that the computing device (300) may perform other functionalities without departing from the scope of the embodiments described herein.

Examples of the computing device (300) may include, but are not limited to, a desktop computer, a laptop computer, a network server, a smartphone, a tablet computer, or any computing system similar to the exemplary computing system illustrated and described with respect to FIG. 7, below.

In one or many embodiment(s) described herein, the computing device (300) may include one or more virtual machines (302A-302P), a hypervisor (308), a device OS (310) optionally, and device resources (312). Each of these computing device (300) components is described below.

In one or many embodiment(s) described herein, any virtual machine (302A-302P) may refer to a computer program, or computer readable instructions, which when executed or invoked, emulates a physical host system (e.g., computing device (300)). To said extent, and at least in part, any virtual machine (302A-302P) may include functionality to provide an isolated virtualization environment wherein one or more applications (304A-304Q) (described above—see e.g., FIGS. 1 and 2) and a guest OS (306) (described below) may execute. One of ordinary skill, however, will appreciate that any virtual machine (302A-302P) may perform other functionalities without departing from the scope of the embodiments described herein.

In one or many embodiment(s) described herein, any application (304A-304Q), executing within any virtual machine (302A-302P), may operate as a resource consumer (314) (described above—see e.g., FIG. 1).

In one or many embodiment(s) described herein, the guest OS (306) may refer to a computer program, or computer readable instructions, which when executed or invoked, implement an OS within a virtual machine (302A-302P). To that extent, and at least in part, the guest OS (306) may include functionality to: perform one or more tasks responsible for overseeing virtual machine (302A-302P) operations, such as: scheduling fundamental virtual machine (302A-302P) functions; mediating interactivity between any application(s) (304A-304Q) also executing in the virtual machine (302A-302P) and the hypervisor (308); allocating and/or de-allocating any granularity of the device resources (312) as needed to support any application(s) (304A-304Q) executing in the virtual machine (302A-302P); and execute or invoke other computer program(s) and/or computer readable instructions within the confines of the virtual machine (302A-302P). One of ordinary skill, however, will appreciate that the guest OS (306) may perform other functionalities without departing from the scope of the embodiments described herein.

In one or many embodiment(s) described herein, the guest OS (306), executing within any virtual machine (302A-302P), may operate as a resource allocator (316) (described above—see e.g., FIG. 1). Further, any resource allocator (316) may include functionality to: determine whether to optimize resource allocation amongst multiple resource consumers (314) as illustrated and described with respect to FIG. 6A, below; and optimize resource allocation amongst multiple resource consumers (314) as illustrated and described with respect to FIGS. 6B and 6C, below.

In one or many embodiment(s) described herein, the hypervisor (308) may refer to a computer program, or computer readable instructions, which when executed or invoked, manages the lifecycle of any virtual machine(s) (302A-302P) executing on the computing device (300). To said extent, and at least in part, the hypervisor (308) may include functionality to: create and configure any virtual machine(s) (302A-302P) with the necessary physical resources to effect their proper execution; install the guest OS (306) and any application(s) (304A-304Q) in each of the virtual machine(s) (302A-302P); deploy and thus activate any virtual machine(s) (302A-302P); monitor and maintain any virtual machine(s) (302A-302P) to ensure optimal health, performance, and security; and deactivate and decommission any virtual machine(s) (302A-302P) no longer in use. One of ordinary skill, however, will appreciate that the hypervisor (308) may perform other functionalities without departing from the scope of the embodiments described herein.

For example, when requesting any physical resources needed to support the execution of any virtual machine(s) (302A-302P), the hypervisor (308) may either interface with the device OS (310) if the latter is installed, or may alternatively interface with the device resources (312) should the device OS (310) not be installed.

In one or many embodiment(s) described herein, the device OS (310) (if installed on the computing device (300)) may refer to a computer program, or computer readable instructions, which when executed or invoked, performs one or more tasks responsible for overseeing computing device (300) operations. To said extent, and at least in part, the device OS (310) may include functionality to: schedule fundamental computing device (300) functions; mediate interactivity between any logical (e.g., hypervisor (308)) and any physical (e.g., device resources (312)) components of the computing device (300); allocate and/or de-allocate any granularity of the device resources (312) as needed to service any number of received system calls; and execute or invoke other computer program(s) and/or computer readable instructions. One of ordinary skill, however, will appreciate that the device OS (310) may perform other functionalities without departing from the scope of the embodiments described herein.

In one or many embodiment(s) described herein, the device resources (312) may refer to any number of physical resources natively available to, or physically installed on, the computing device (300). Further, said physical resources may be segmented into various resource types each defining a subset of the device resources (312). Said various resource types may include compute resources (not shown), memory resources (not shown), storage resources (not shown), networking resources (not shown), and accelerated compute resources (not shown) (all described above—see e.g., FIG. 1).

While FIG. 3 shows a configuration of components and/or subcomponents, other computing device (300) configurations may be used without departing from the scope of the embodiments described herein.

For example, in one or many other embodiment(s) described herein, alternate computing device configurations may resemble those illustrated and described above and below with respect to FIGS. 1, 2, and 4.

By way of another example, in one or many embodiment(s) described herein, any alternate computing device configuration(s) may reflect a combination of the above-described computing device (300) with one or more of the previous or subsequent computing device(s) illustrated and described above or below with respect to FIGS. 1, 2, and 4.

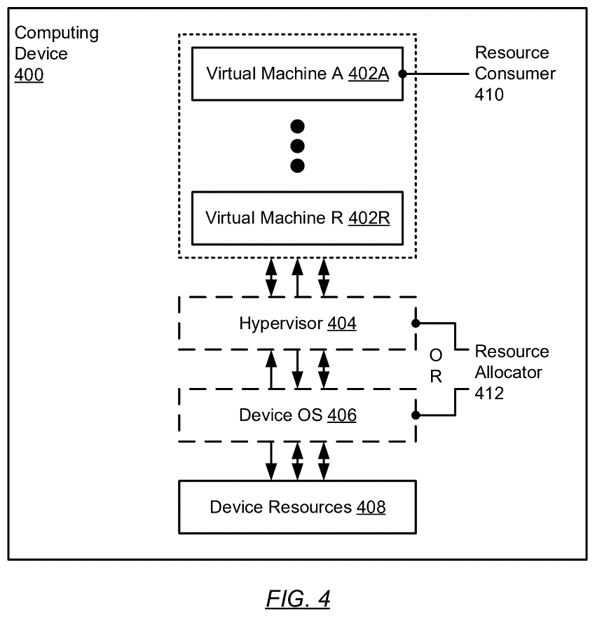

FIG. 4 shows a computing device in accordance with one or more embodiments described herein. The computing device (400) may represent a physical appliance at least configured to receive, generate, process, store, and/or transmit data, as well as provide an environment in which one or many workload(s) (not shown) (described above—see e.g., FIG. 1) may be performed thereon. One of ordinary skill, however, will appreciate that the computing device (400) may perform other functionalities without departing from the scope of the embodiments described herein.

Examples of the computing device (400) may include, but are not limited to, a desktop computer, a laptop computer, a network server, a smartphone, a tablet computer, or any computing system similar to the exemplary computing system illustrated and described with respect to FIG. 7, below.

In one or many embodiment(s) described herein, the computing device (400) may include one or more virtual machines (402A-402R), a hypervisor (404) or a device OS (406), and device resources (408). Each of these computing device (400) components is described below.

In one or many embodiment(s) described herein, any virtual machine (402A-402R) may refer to a computer program, or computer readable instructions, which when executed or invoked, emulates a physical host system (e.g., computing device (400)). To said extent, and at least in part, any virtual machine (402A-402R) may include functionality to provide an isolated virtualization environment wherein one or more applications (not shown) (described above—see e.g., FIGS. 1-3) and a guest OS (not shown) (described above—see e.g., FIG. 3) may execute. One of ordinary skill, however, will appreciate that any virtual machine (402A-402R) may perform other functionalities without departing from the scope of the embodiments described herein.

In one or many embodiment(s) described herein, any virtual machine (402A-402R) may operate as a resource consumer (410) (described above—see e.g., FIG. 1).

In one or many embodiment(s) described herein, the hypervisor (404) (if installed on the computing device (400)) may refer to a computer program, or computer readable instructions, which when executed or invoked, manages the lifecycle of any virtual machine(s) (402A-402R) executing on the computing device (400). To said extent, and at least in part, the hypervisor (404) may include functionality to: create and configure any virtual machine(s) (402A-402R) with the necessary physical resources to effect their proper execution; install the guest OS and any application(s) in each of the virtual machine(s) (402A-402R); deploy and thus activate any virtual machine(s) (402A-402R); monitor and maintain any virtual machine(s) (402A-402R) to ensure optimal health, performance, and security; and deactivate and decommission any virtual machine(s) (402A-402R) no longer in use. One of ordinary skill, however, will appreciate that the hypervisor (404) may perform other functionalities without departing from the scope of the embodiments described herein.

For example, when requesting any physical resources needed to support the execution of any virtual machine(s) (402A-402R), the hypervisor (404) may either interface with the device OS (406) if the latter is installed, or may alternatively interface with the device resources (408) should the device OS (406) not be installed.

In one or many embodiment(s) described herein, the device OS (406) (if installed on the computing device (400)) may refer to a computer program, or computer readable instructions, which when executed or invoked, performs one or more tasks responsible for overseeing computing device (400) operations. To said extent, and at least in part, the device OS (406) may include functionality to: schedule fundamental computing device (400) functions; mediate interactivity between any logical (e.g., any virtual machine(s) (402A-402R) and the hypervisor (404) (if installed)) and any physical (e.g., device resources (408)) components of the computing device (400); allocate and/or de-allocate any granularity of the device resources (408) as needed to service any number of received system calls; and execute or invoke other computer program(s) and/or computer readable instructions. One of ordinary skill, however, will appreciate that the device OS (406) may perform other functionalities without departing from the scope of the embodiments described herein.

In one or many embodiment(s) described herein, the hypervisor (404) or the device OS (406) (whichever is installed) may operate as a resource allocator (412) (described above—see e.g., FIG. 1). Further, any resource allocator (412) may include functionality to: determine whether to optimize resource allocation amongst multiple resource consumers (410) as illustrated and described with respect to FIG. 6A, below; and optimize resource allocation amongst multiple resource consumers (410) as illustrated and described with respect to FIGS. 6B and 6C, below

In one or many embodiment(s) described herein, the device resources (408) may refer to any number of physical resources natively available to, or physically installed on, the computing device (400). Further, said physical resources may be segmented into various resource types each defining a subset of the device resources (408). Said various resource types may include compute resources (not shown), memory resources (not shown), storage resources (not shown), networking resources (not shown), and accelerated compute resources (not shown) (all described above—see e.g., FIG. 1).

While FIG. 4 shows a configuration of components and/or subcomponents, other computing device (400) configurations may be used without departing from the scope of the embodiments described herein.

For example, in one or many embodiment(s) described herein, alternate computing device configurations may resemble those illustrated and described above with respect to FIGS. 1-3.

By way of another example, in one or many embodiment(s) described herein, any alternate computing device configuration(s) may reflect a combination of the above-described computing device (200) with one or more of the previous computing device(s) illustrated and described above with respect to FIGS. 1-3.

FIG. 5 shows a hyper-converged infrastructure (HCI) cluster in accordance with one or more embodiments described herein. The HCI cluster (500) may represent any information technology (IT) infrastructure, configured as a group of linked physical appliances (i.e., two or more cluster devices (502A-502S) (described below)), that reflects hyper-convergent architecture. Hyper-convergent architecture, in turn, may entail the software-centric or software-defined integration of physical resources (i.e., device resources (508)) into a single solution.

In one or many embodiment(s) described herein, any cluster device (502A-502S) may represent a physical appliance at least configured to receive, generate, process, store, and/or transmit data, as well as provide an environment in which one or many workload(s) (not shown) (described above—see e.g., FIG. 1) may be performed thereon. One of ordinary skill, however, will appreciate that any cluster device (502A-502S) may perform other functionalities without departing from the scope of the embodiments described herein.

Examples of any cluster device (502A-502S) may include, but are not limited to, a desktop computer, a laptop computer, a network server, a smartphone, a tablet computer, or any computing system similar to the exemplary computing system illustrated and described with respect to FIG. 7, below.

In one or many embodiment(s) described herein, any cluster device (502A-502S) may include one or more virtual machines (504A-504T), a hypervisor (506), and device resources (508). Each of these cluster device (502A-502S) components is described below.

In one or many embodiment(s) described herein, any virtual machine (504A-504T) may refer to a computer program, or computer readable instructions, which when executed or invoked, emulates a physical host system (e.g., any cluster device (502A-502S)). To said extent, and at least in part, any virtual machine (504A-504T) may include functionality to provide an isolated virtualization environment wherein one or more applications (not shown) (described above—see e.g., FIGS. 1-3) and a guest OS (not shown) (described above—see e.g., FIG. 3) may execute. One of ordinary skill, however, will appreciate that any virtual machine (504A-504T) may perform other functionalities without departing from the scope of the embodiments described herein.

In one or many embodiment(s) described herein, any virtual machine (504A-504T) may operate as a resource consumer (514) (described above—see e.g., FIG. 1).

In one or many embodiment(s) described herein, the hypervisor (506) may refer to a computer program, or computer readable instructions, which when executed or invoked, manages the lifecycle of any virtual machine(s) (504A-504T) executing on their respective cluster device (502A-502S). To said extent, and at least in part, the hypervisor (506) may include functionality to: create and configure any virtual machine(s) (504A-504T) with the necessary physical resources to effect their proper execution; install the guest OS and any application(s) in each of the virtual machine(s) (504A-504T); deploy and thus activate any virtual machine(s) (504A-504T); monitor and maintain any virtual machine(s) (504A-504T) to ensure optimal health, performance, and security; and deactivate and decommission any virtual machine(s) (504A-504T) no longer in use. One of ordinary skill, however, will appreciate that the hypervisor (506) may perform other functionalities without departing from the scope of the embodiments described herein.

In one or many embodiment(s) described herein, the device resources (508) may refer to any number of physical resources natively available to, or physically installed on, the cluster device (502A-502S). Further, said physical resources may be segmented into various resource types each defining a subset of the device resources (508). Said various resource types may include compute resources (not shown), memory resources (not shown), storage resources (not shown), networking resources (not shown), and accelerated compute resources (not shown) (all described above—see e.g., FIG. 1).

In one or many embodiment(s) described herein, in reflecting hyper-convergent architecture, the cluster devices (502A-502S) share their respective device resources (508). That is, each available resource type, across the cluster devices (502A-502S), may be virtualized to collectively create a logical pool of said available resource type.

For example, for a HCI cluster including two cluster devices: (a) any compute resources on a first cluster device and any compute resources on a second cluster device are virtualized to produce a logical compute resources pool; (b) any memory resources on the first cluster device and any memory resources on the second cluster device are virtualized to produce a logical memory resources pool; (c) any storage resources on the first cluster device and any storage resources on the second cluster device are virtualized to produce a logical storage resources pool; (d) any networking resources on the first cluster device and any networking resources on the second cluster device are virtualized to produce a logical networking resources pool; and (e) any accelerated compute resources on the first cluster device and any accelerated compute resources on the second cluster device are virtualized to produce a logical accelerated compute resources pool.

Further, in one or many embodiment(s) described herein, the combination of all the logical pools, spanning the HCI cluster (500), may be referred to herein as the cluster resources pool (512). Similarly, the culmination of all the hypervisors (506), across the cluster devices (502A-502S), may form and thus be referred to herein as the cluster resources manager (510).

In one or many embodiment(s) described herein, the cluster resource manager (510) may operate as a resource allocator (516) (described above—see e.g., FIG. 1). Further, any resource allocator (516) may include functionality to: determine whether to optimize resource allocation amongst multiple resource consumers (514) as illustrated and described with respect to FIG. 6A, below; and optimize resource allocation amongst multiple resource consumers (514) as illustrated and described with respect to FIGS. 6B and 6C, below.

While FIG. 5 shows a configuration of components and/or subcomponents, other HCI cluster (500) configurations may be used without departing from the scope of the embodiments described herein.

FIG. 6A shows a flowchart outlining a method for determining whether to optimize resource allocation amongst multiple resource consumers in accordance with one or more embodiments described herein. The various steps outlined below may be performed by any resource allocator (see e.g., FIGS. 1-5). Further, while the various steps in the flowchart are presented and described sequentially, one of ordinary skill will appreciate that some or all steps may be executed in different orders, may be combined or omitted, and some or all steps may be executed in parallel.

Turning to FIG. 6A, in one or many embodiment(s) described herein, Steps 600, 602, and 604 (each described below) are to be performed concurrently or in parallel.

In Step 600, resources on a host system are monitored. In one or many embodiment(s) described herein, the host system may reflect a computing device (see e.g., FIGS. 1-4) and the resources thereon may thus entail device resources. In one or many other embodiment(s) described herein, the host system may alternatively reflect a HCI cluster (see e.g., FIG. 5) and the resources thereon may thus entail a cluster resources pool. Further, monitoring of said resources may involve periodic checks of each resource type (e.g., compute resources, memory resources, storage resources, networking resources, and accelerated compute resources) collectively forming said resources for changes in total resource type units (exemplified above—see e.g., FIG. 1) of said resource type installed on (or accessible to) the host system.

In Step 602, resource consumers, executing on a host system (described above—see e.g., Step 600), are monitored. In one or many embodiment(s) described herein, the resources consumers may include one or more of any of the following entities (separately or in combination): applications; containers; and virtual machines. Further, monitoring of said resource consumers may involve periodic checks thereof for changes in their total number executing on said host system.

In Step 604, workloads, being performed on a host system (described above—see e.g., Step 600), are monitored. In one or many embodiment(s) described herein, any workload (exemplified above—see e.g., FIG. 1) may refer to the utilization of resources to effect work within a computing environment (e.g., the host system) and, therefore, may be instantiated, run, or otherwise supported, by a resource consumer (exemplified above—see e.g., Step 602). Further, monitoring of said workloads may involve periodic checks thereof for changes in their total number supported on said host system, and/or for changes in their demand for resources.

In Step 606, based on the resources (monitored in Step 600), a determination is made as to whether a change is observed in the total resource type units of any resource type installed on (or accessible to) the host system. Changes in the total resource type units of any resource type may entail an increase thereof (e.g., due to the installation/accessibility of additional integrated circuits or non-transitory computer readable media on/to the host system) or a decrease thereof (e.g., due to the failure of existing integrated circuits or non-transitory computer readable media installed/accessible on/to the host system).

Accordingly, in one or many embodiment(s) described herein, if it is determined that a change, in the total resource type units of any resource type installed on (or accessible to) the host system, is observed, then the method proceeds to Step 612. On the other hand, in one or many other embodiment(s) described herein, if it is alternatively determined that no such change is observed, then the method alternatively proceeds (back) to Step 600, where further monitoring of the resources transpires.

In Step 608, based on the resource consumers (monitored in Step 602), a determination is made as to whether a change is observed in the total number of said resource consumers executing on the host system. Changes in the total number of resource consumers may entail an increase thereof (e.g., due to the commissioning of additional resource consumers to support additional workloads) or a decrease thereof (e.g., due to the decommissioning of existing resource consumers when existing workloads complete).

Accordingly, in one or many embodiment(s) described herein, if it is determined that a change, in the total number of resources consumers executing on the host system, is observed, then the method proceeds to Step 612. On the other hand, in one or many other embodiment(s) described herein, if it is alternatively determined that no such change is observed, then the method alternatively proceeds (back) to Step 602, where further monitoring of the resource consumers transpires.

In Step 610, based on the workloads (monitored in Step 604), a determination is made as to whether a change is observed in the total number of said workloads supported on the host system, and/or the demand for resources sought by said workloads. Changes in the total number of workloads may entail an increase thereof (e.g., due to the performance of additional workloads being sought by users) or a decrease thereof (e.g., due to completion of existing workloads that had been performed through the host system). Further, changes in the demand for resources by said workloads may entail an increase thereof (e.g., due to an expansion in the intensity and/or complexity of the work being performed) or a decrease thereof (e.g., due to a reduction in the intensity and/or complexity of work being performed).

Accordingly, in one or many embodiment(s) described herein, if it is determined that a change, in the total number of workloads supported on the host system and/or in the demand for resources by said workloads, is/are observed, then the method proceeds to Step 612. On the other hand, in one or many other embodiment(s) described herein, if it is alternatively determined that no such change(s) is/are observed, then the method alternatively proceeds (back) to Step 604, where further monitoring of the workloads transpires.

In Step 612, (a) following a first determination (made in Step 606) that a change has been observed in the total resource type units of any resource type installed on (or accessible to) the host system; (b) following a second determination (made in Step 608) that a change has been observed in the total number of resource consumers executing on the host system; and/or (c) following a third determination (made in Step 610) that a change has been observed in the total number of workloads supported on the host system: a resource allocation of the resources (e.g., device resources or cluster resources pool), on/of the host system, amongst multiple resource consumers is optimized. Optimization of said resource allocation is illustrated and described in further detail below with respect to FIGS. 6B and 6C.

Hereinafter, in one or many embodiment(s) described herein, the method proceeds (back) to each of Steps 600, 602, and 604, which are performed concurrently or in parallel, thereby enabling further monitoring of the resources, the resource consumers, and the workloads (as described above).

FIGS. 6B and 6C show a flowchart outlining a method for optimizing resource allocation amongst multiple resource consumers in accordance with one or more embodiments described herein. The various steps outlined below may be performed by any resource allocator (see e.g., FIGS. 1-5). Further, while the various steps in the flowchart are presented and described sequentially, one of ordinary skill will appreciate that some or all steps may be executed in different orders, may be combined or omitted, and some or all steps may be executed in parallel.

Hereinafter, the method outlined below will be accompanied by two examples each demonstrating a scenario entailing at least a subset of the various steps forming said method. Said examples, further, are for explanatory purposes only and not intended to limit the scope of the embodiments described herein.

Turning to FIG. 6B, in Step 620, a resource type is selected. In one or many embodiment(s) described herein, said resource type may refer to one of the following: compute resources, memory resources, storage resources, networking resources, or accelerated compute resources. Further, said resource type may define a subset of the resources installed on (or accessible to) a host system (e.g., a computing device or a HCI cluster).

### Example 1

Selected Resource Type:compute resources

### Example 2

Selected Resource Type:memory resources

In Step 622, a number (or cardinality) of available resource type units is identified. In one or many embodiment(s) described herein, any resource type unit may generally refer to a standard measurement of a particular resource type that may be requested, allocated, consumed, and de-allocated. Considering the resource type (selected in Step 620), said resource type unit of said resource type may reflect one of the following (respectively): a processor core, a memory byte, a storage byte, a networking bps, or an accelerated core. Further, the number of available resource type units may refer to a total number of (allocated and unallocated) resource type units of the selected resource type installed on or accessible to the host system.

### Example 1

$$No . of Available Resource Type Units ( u ) = 24 cores$$

### Example 2

$$No . of Available Resource Type Units ( u ) = 300 GB$$

In Step 624, a number (or cardinality) of resource consumers is identified. In one or many embodiment(s) described herein, said resource consumer(s) may include one or more of the following entities (separately or in combination) that may be currently executing on the host system: applications, containers, and/or virtual machines. For example, ten (10) applications is currently executing on the host system, and therefore, the number of resource consumers is ten (10). By way of another example, five (5) applications, two (2) containers, and eight (8) virtual machines is currently executing on the host system, and therefore, the number of resource consumers is fifteen (15). Said resource consumer(s) may thus contend with one another at least for the resource type (selected in Step 620) of the resources installed on (or accessible to) said host system.

### Example 1

$$No . of Resource Consumers ( c ) = 3 virtual machines supporting 5 , 2 , and 7 applications ( a ) , respectively$$

### Example 2

$$No . of Resource Consumers ( c ) = 2 applications supporting themselves ( a = 1 ) , respectively$$

In Step 626, for each resource consumer of the resource consumers (identified in Step 624), a type-driven consumer workload weight is computed. In one or many embodiment(s) described herein, said type-driven consumer workload weight may refer to a normalized numerical value reflecting how demanding the workload(s) supported by a resource consumer is/are in terms of the resource type (selected in Step 620). Further, said type-driven consumer workload weight may be expressed or computed differently depending on said resource type.

For example, for compute resources and accelerated compute resources, the type-driven consumer workload weight may equal the summation of the estimated time (Eᵢ) (e.g., in seconds) that a request is serviced relative to the maximum time (Mᵢ) (e.g., in seconds) allowed for said request to be serviced by each application (i) of the at least one application (a) (performing a workload) defining or supported by the resource consumer—i.e.,

$${\sum }_{i = 1}^{a} {E}_{i} / {M}_{i} .$$

For a given virtual machine operating as a resource consumer, said at least one application may be reflected by any whole number as one or many application(s) may execute within, and thus is/are supported by, said given virtual machine. For a given container operating as a resource consumer, said at least one application may be reflected by the numerical value of one (1) as a singular application may execute within, and thus is supported by, said given container. For a given application operating as a resource consumer, said at least one application may be reflected by the numerical value of one (1) as the given application supports only itself.

By way of another example, for memory resources and storage resources, the type-driven consumer workload weight may equal the estimated memory (or storage) space (E) (e.g., in bytes) consumed/used by the resource consumer relative to the maximum memory (or storage) space (M) (e.g., in bytes) allowed to be consumed/used by said resource consumer—i.e.,

$${\sum }_{i = 1}^{a = 1} {E}_{i} / {M}_{i} = E / M .$$

### Example 1

Given the estimated time for a request to be serviced (E) and the maximum time for said request to be serviced (M) by each of the 5 applications (a) supported by the first virtual machine (VM) as tabled below:

| Application (i) | Est. Service Time (Eᵢ) | Max. Service Time (Mᵢ) |
|---|---|---|
| 1 | 9 sec | 10 sec |
| 2 | 2 sec | 5 sec |
| 3 | 2 sec | 2 sec |
| 4 | 4.5 sec | 5 sec |
| 5 | 4 sec | 5 sec |

$$Type Driven Consumer Workload Weight for First VM ( {w}_{1} ) = {\sum }_{i = 1}^{a = 5} {E}_{i} / {M}_{i} = \frac{9}{10} + \frac{2}{5} + \frac{2}{2} + \frac{4.5}{5} + \frac{4}{5} = 4$$

Given the estimated time for a request to be serviced (E) and the maximum time for any request to be serviced (M) by each of the 2 applications (a) supported by the second virtual machine (VM) as tabled below:

| Application (i) | Est. Service Time (Eᵢ) | Max. Service Time (Mᵢ) |
|---|---|---|
| 1 | 3 sec | 6 sec |
| 2 | 2 sec | 4 sec |

$$Type Driven Consumer Workload Weight for Second VM ( {w}_{2} ) = {\sum }_{i = 1}^{a = 2} {E}_{i} / {M}_{i} = \frac{3}{6} + \frac{2}{4} = 1$$

Given the estimated time for a request to be serviced (E) and the maximum time for any request to be serviced (M) by each of the 7 applications (a) supported by the third virtual machine (VM) as tabled below:

| Application (i) | Est. Service Time (Eᵢ) | Max. Service Time (Mi) |
|---|---|---|
| 1 | 4 sec | 4 sec |
| 2 | 1.5 sec | 5 sec |
| 3 | 8 sec | 10 sec |
| 4 | 2 sec | 4 sec |
| 5 | 2 sec | 5 sec |
| 6 | 6 sec | 8 sec |
| 7 | 3 sec | 12 sec |

$$Type Driven Consumer Workload Weight for Third VM ( {w}_{3} ) = {\sum }_{i = 1}^{a = 7} {E}_{i} / {M}_{i} = \frac{4}{4} + \frac{1.5}{5} + \frac{8}{10} + \frac{2}{4} + \frac{2}{5} + \frac{6}{8} + \frac{3}{12} = 4$$

### Example 2

Given the estimated memory space (E) and the maximum allowed memory space (M) that may be consumed by each of the 2 applications as tabled below:

| Application | Est. Memory Space (E) | Max. Memory Space (M) |
|---|---|---|
| 1 | 125 GB | 5 GB |
| 2 | 45 GB | 5 GB |

$$Type Driven Consumer Workload Weight for First App ( {w}_{1} ) = \frac{E}{M} = \frac{125}{5} = 25$$

$$Type Driven Consumer Workload Weight for Second App ( {w}_{2} ) = \frac{E}{M} = \frac{45}{5} = 9$$

In Step 628, a division of available resource type units is computed. In one or many embodiment(s) described herein, said division of available resource type units (xᵢ) may refer to a preliminary allocation of the number of available resource type units (u) (identified in Step 622) amongst the number of resource consumers (c) (identified in Step 624). Further, computation of said division of available resource type units may involve (or be based on) the type-driven consumer workload weights (wᵢ) (computed in Step 626) and said number of available resource type units—i.e., x₁: x₂: . . . : x_{c}=p·[x′₁: x′₂: . . . : x′_{c}],
where: x′₁: x′₂: . . . : x′_{c}=\sqrt{w₁}: \sqrt{w₂}: . . . : \sqrt{w_{c}};

$$p = u / {\sum }_{i = 1}^{c} \sqrt{{w}_{i}} ; 0 \leq {x}_{i} \leq u ; and {\sum }_{i = 1}^{c} {x}_{i} = u$$

### Example 1

Division of Available Resource Type Units for c=3 VMs:

$${x}_{1}^{′} : {x}_{2}^{′} : {x}_{3}^{′} = \sqrt{{w}_{1}} : \sqrt{{w}_{2}} : \sqrt{{w}_{3}} = \sqrt{4} : \sqrt{1} : \sqrt{4} = 2 : 1 : 2$$

$$p = u / {\sum }_{i = 1}^{c = 3} \sqrt{{w}_{i}} = 24 / [ \sqrt{4} + \sqrt{1} + \sqrt{4} ] = 24 / 5 = 4.8 \to {x}_{1} : {x}_{2} : {x}_{3} = p \cdot [ {x}_{1}^{′} : {x}_{2}^{′} : {x}_{3}^{′} ] = 4.8 \cdot [ 2 : 1 : 2 ] \approx 10 : 4 : 10 cores$$

### Example 2

Division of Available Resource Type Units for c=2 Apps:

$${x}_{1}^{′} : {x}_{2}^{′} = \sqrt{{w}_{1}} : \sqrt{{w}_{2}} = \sqrt{25} : \sqrt{9} = 5 : 3$$

$$p = u / {\sum }_{i = 1}^{c = 2} \sqrt{{w}_{i}} = 300 / [ \sqrt{25} + \sqrt{9} ] = 300 / 8 = 3 7.5 \to {x}_{1} : {x}_{2} = p \cdot [ {x}_{1}^{′} : {x}_{2}^{′} ] = 3 \; 7.5 \cdot [ 5 : 3 ] = 187.5 : 112.5 GB$$

In Step 630, a total resource usage is computed. In one or many embodiment(s) described herein, said total resource usage may refer to a numerical value reflecting the prospective utilization (or consumption) of resources of the resource type (selected in Step 620) by the resource consumers (c) (as a collective) on the host system. Further, computation of said total resource usage (U_{R}) may involve (or be based on) the type-driven consumer workload weights (wᵢ) (computed in Step 626) and the division of available resource type units (xᵢ) (computed in Step 628)—i.e.,

$${U}_{R} = {\sum }_{i = 1}^{c} {w}_{i} / {x}_{i} .$$

### Example 1

$$Total Resource Usage of Compute Resources ( {U}_{R} ) = {\sum }_{i = 1}^{c = 3} {w}_{i} / {x}_{i} = \frac{{w}_{1}}{{x}_{1}} + \frac{{w}_{2}}{{x}_{2}} + \frac{{w}_{3}}{{x}_{3}} = \frac{4}{10} + \frac{1}{4} + \frac{4}{10} = 1.05$$

### Example 2

$$Total Resource Usage of Memory Resources ( {U}_{R} ) = {\sum }_{i = 1}^{c = 2} {w}_{i} / {x}_{i} = \frac{25}{187.5} + \frac{9}{112.5} = 0.213$$

In Step 632, a determination is made as to whether the total resource usage (computed in Step 630) exceeds the numerical value of one (1). Accordingly, in one or many embodiment(s) described herein, if it is determined that the total resource usage is greater than one (1), then the method proceeds to Step 634. On the other hand, in one or many other embodiment(s) described herein, if it is alternatively determined that the total resource usage is less than or equal to one (1), then the method alternatively proceeds to Step 636 (see e.g., FIG. 6C).

### Example 1

$${U}_{R} = 1.05 > 1 \to Step 634$$

### Example 2

$${U}_{R} = 0.213 \leq 1 \to Step 636$$

In Step 634, following the determination (made in Step 632) that the total resource usage (computed in Step 630) is greater than one (1), the number of available resource type units (identified in Step 622) is expanded. In one or many embodiment(s) described herein, expansion of the number of available resource type units may entail the installation or accessibility of additional integrated circuits or non-transitory computer readable media, contingent on the resource type (selected in Step 620), on or to the host system.

For example, if the selected resource type is compute resources, then expansion of the number of available resource type units (e.g., processor cores) would involve the installation/accessibility of more CPUs. By way of another example, if the selected resource type is storage resources, then expansion of the number of available resource type units (e.g., storage bytes) would instead involve the installation/accessibility of more optical, magnetic, and/or solid-state storage devices. Further, said expansion of the number of available resource type units is necessary since the total resource usage exceeds one (1) indicating that the prospective utilization (or consumption) of resources of the resource type (selected in Step 620) by the number of resource consumers (identified in Step 624) on the host system would exceed one-hundred percent (100%), thereby deeming said utilization/consumption of resources impossible considering the current availability of resource type units.

### Example 1

$$New No . of Available Resource Type Units ( u ) = 25 cores$$

Hereinafter, the method proceeds (back) to Step 628, where a new division of available resource type units may be computed based on a new number of available resource type units that further accounts for the additional resources of the resource type (selected in Step 620) after their respective installation on (or accessibility to) the host system.

### Example 1

New Division of Available Resource Type Units for c=3 VMs:

$${x}_{1}^{′} : {x}_{2}^{′} : {x}_{3}^{′} = \sqrt{{w}_{1}} : \sqrt{{w}_{2}} : \sqrt{{w}_{3}} = \sqrt{4} : \sqrt{1} : \sqrt{4} = 2 : 1 : 2$$

$$p = u / {\sum }_{i = 1}^{c = 3} \sqrt{{w}_{i}} = 25 / [ \sqrt{4} + \sqrt{1} + \sqrt{4} ] = 25 / 5 = 5 \to {x}_{1} : {x}_{2} : {x}_{3} = p \cdot [ {x}_{1}^{′} : {x}_{2}^{′} : {x}_{3}^{′} ] = 5 \cdot [ 2 : 1 : 2 ] \approx 10 : 5 : 10 cores$$

$$New Total Resource Usage of Compute Resources ( {U}_{R} ) = {\sum }_{i = 1}^{c = 3} {w}_{i} / {x}_{i} = \frac{{w}_{1}}{{x}_{1}} + \frac{{w}_{2}}{{x}_{2}} + \frac{{w}_{3}}{{x}_{3}} = \frac{4}{10} + \frac{1}{5} + \frac{4}{10} = 1$$

$$New {U}_{R} = 1 \leq 1 \to Step 636$$

Turning to FIG. 6C, in Step 636, following the alternate determination (made in Step 632) that the total resource usage (computed in Step 630) is less than or equal to one (1), a determination is made as to whether said total resource usage equals the numerical value of one (1).

Accordingly, in one or many embodiment(s) described herein, if it is determined that the total resource usage is equal to one (1), then the method proceeds to Step 638. On the other hand, in one or many other embodiment(s) described herein, if it is alternatively determined that the total resource usage is not equal to one (1), then the method alternatively proceeds to Step 640.

### Example 1

$${U}_{R} = 1 = 1 \to Step 638$$

### Example 2

$${U}_{R} = 0.213 \neq 1 \to Step 640$$

In Step 638, following the determination (made in Step 636) that the total resource usage (computed in Step 630) is equal to one (1), the number of available resource type units (identified in Step 622) are allocated amongst the number of resource consumers (identified in Step 624). In one or many embodiment(s) described herein, said allocation of the available resource type units (u) may be distributed based on the division of available resource type units (xᵢ) (computed in Step 628).

### Example 1

First VM is allocated 10 cores, Second VM is allocated 5 cores, and Third VM is allocated 10 cores (of 25 total cores)

In Step 640, following the alternate determination (made in Step 636) that the total resource usage (computed in Step 630) is not equal to one (1), a least upper bound of the total resource usage is computed. In one or many embodiment(s) described herein, said least upper bound of the total resource usage may refer to a numerical value reflecting a minimum number of available resource type units required to ensure that sufficient resources of the resource type (selected in Step 620) are made available for allocation and consumption amongst the resource consumers (identified in Step 624). Further, computation of said least upper bound of the total resource usage (LUB_{UR}) may involve (or be based on) said total resource usage (U_{R}) and said number of available resource type units (u) (identified in Step 622) —i.e., LUB_{UR}=U_{R}·u.

### Example 2

$$Least Upper Bound of Total Resource Usage ( {LUB}_{UR} ) = {U}_{R} \cdot u = 0 \text{.213} \cdot 300 GB = 64 GB$$

In Step 642, the number of available resource type units (identified in Step 622) is adjusted. Particularly, in one or many embodiment(s) described herein, said number of available resource type units (u) may be adjusted to match the numerical value reflective of the least upper bound of the total resource usage (LUB_{UR}) (computed in Step 640).

### Example 2

$$New No . of Available Resource Type Units ( u ) = {LUB}_{UR} = 64 GB$$

In Step 644, a new division of available resource type units (xᵢ) is computed based on the number of available resource type units (u) (adjusted in Step 642).

### Example 2

New Division of Available Resource Type Units for c=2 Apps:

$${x}_{1}^{′} : {x}_{2}^{′} = \sqrt{{w}_{1}} : \sqrt{{w}_{2}} = \sqrt{25} : \sqrt{9} = 5 : 3$$

$$p = u / {\sum }_{i = 1}^{c = 2} \sqrt{{w}_{i}} = 64 / [ \sqrt{25} + \sqrt{9} ] = 64 / 8 = 8 \to {x}_{1} : {x}_{2} = p \cdot [ {x}_{1}^{′} : {x}_{2}^{′} ] = 8 \cdot [ 5 : 3 ] = 40 : 24 GB$$

Hereinafter, the method proceeds to Step 638, where the number of available resource type units (adjusted in Step 642) are allocated amongst the number of resource consumers (identified in Step 624). Further, said allocation of the available resource type units (u) may be distributed based on the new division of available resource type units (xᵢ) (computed in Step 644).
First App allocated 40 GB and Second App allocated 24 GB (of 64 total GB)

While the method outlined above in FIGS. 6B and 6C considers a single resource type (selected in Step 620), the method may be performed more than one time with each iteration dedicated to the selection of a different resource type of the resources installed on (or accessible to) the host system.

FIG. 7 shows a computing system in accordance with one or more embodiments described herein. The computing system (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one or many embodiment(s) described herein, the computer processor(s) (702) may be an integrated circuit for processing instructions. For example, the computer processor(s) may be one or more cores or micro-cores of a central processing unit (CPU) and/or a graphics processing unit (GPU). The computing system (700) may also include one or more input devices (710), such as a touchscreen, keyboard, mouse, microphone, touchpad, electronic pen, or any other type of input device. Further, the communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

In one or many embodiment(s) described herein, the computing system (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing systems exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments described herein.

While the embodiments described herein have been described with respect to a limited number of embodiments, those skilled in the art, having benefit of this disclosure, will appreciate that other embodiments can be devised which do not depart from the scope of the embodiments described herein. Accordingly, the scope of the embodiments described herein should be limited only by the attached claims.

What is claimed is:

1. A method for resource allocation optimization, the method comprising:
selecting a resource type from resources on a host system;
computing, based on the resource type, a plurality of weights comprising a weight for each resource consumer of a plurality of resource consumers on the host system;
computing, of the resource type, a total resource usage based on the plurality of weights and a division of available resource type units;
making a determination that the total resource usage equals one; and
allocating, based on the determination, a number of available resource type units of the resource type amongst the plurality of resource consumers.

2. The method of claim 1, wherein the resource type is one of compute resources, memory resources, storage resources, networking resources, and accelerated compute resources.

3. The method of claim 1, wherein the number of available resource type units are allocated amongst the plurality of resource consumers in accordance with the division of available resource type units.

4. The method of claim 1, the method further comprising:
prior to computing the total resource usage:
computing the division of available resource type units based on the plurality of weights and the number of available resource type units.

5. The method of claim 1, wherein the method is triggered upon observation of a change in the number of available resource type units based on a monitoring of the resources on the host system.

6. The method of claim 1, wherein the method is triggered upon observation of a change in a cardinality of the plurality of resource consumers based on a monitoring of the plurality of resource consumers.

7. The method of claim 1, wherein the method is triggered upon observation of a change in a cardinality of at least one workload supported on the host system based on a monitoring of the at least one workload.

8. The method of claim 1, the method further comprising:
selecting a second resource type from the resources on the host system;
computing, based on the second resource type, a second plurality of weights comprising a second weight for each resource consumer of the plurality of resource consumers on the host system;
computing, of the second resource type, a second total resource usage based on the second plurality of weights and a second division of available resource type units;
making a second determination that the second total resource usage is less than one;
computing, based on the second determination, a least upper bound of the second total resource usage;
adjusting, based on the least upper bound, a second number of available resource type units of the second resource type to obtain an adjusted second number of available resource type units;
computing a third division of available resource type units based on the second plurality of weights and the adjusted second number of available resource type units; and
allocating, in accordance with the third division of available resource type units, the adjusted second number of available resource type units of the resource type amongst the plurality of resource consumers.

9. A non-transitory computer readable medium (CRM) comprising computer readable program code, which when executed by at least one computer processor, enables the at least one computer processor to perform a method for resource allocation optimization, the method comprising:
selecting a resource type from resources on a host system;
computing, based on the resource type, a plurality of weights comprising a weight for each resource consumer of a plurality of resource consumers on the host system;
computing, of the resource type, a total resource usage based on the plurality of weights and a division of available resource type units;
making a determination that the total resource usage equals one; and
allocating, based on the determination, a number of available resource type units of the resource type amongst the plurality of resource consumers.

10. The non-transitory CRM of claim 9, wherein the resource type is one of compute resources, memory resources, storage resources, networking resources, and accelerated compute resources.

11. The non-transitory CRM of claim 9, wherein the number of available resource type units are allocated amongst the plurality of resource consumers in accordance with the division of available resource type units.

12. The non-transitory CRM of claim 9, the method further comprising:
prior to computing the total resource usage:
computing the division of available resource type units based on the plurality of weights and the number of available resource type units.

13. The non-transitory CRM of claim 9, wherein the method is triggered upon observation of a change in the number of available resource type units based on a monitoring of the resources on the host system.

14. The non-transitory CRM of claim 9, wherein the method is triggered upon observation of a change in a cardinality of the plurality of resource consumers based on a monitoring of the plurality of resource consumers.

15. The non-transitory CRM of claim 9, wherein the method is triggered upon observation of a change in a cardinality of at least one workload supported on the host system based on a monitoring of the at least one workload.

16. The non-transitory CRM of claim 9, the method further comprising:
selecting a second resource type from the resources on the host system;
computing, based on the second resource type, a second plurality of weights comprising a second weight for each resource consumer of the plurality of resource consumers on the host system;
computing, of the second resource type, a second total resource usage based on the second plurality of weights and a second division of available resource type units;
making a second determination that the second total resource usage is less than one;
computing, based on the second determination, a least upper bound of the second total resource usage;
adjusting, based on the least upper bound, a second number of available resource type units of the second resource type to obtain an adjusted second number of available resource type units;
computing a third division of available resource type units based on the second plurality of weights and the adjusted second number of available resource type units; and
allocating, in accordance with the third division of available resource type units, the adjusted second number of available resource type units of the second resource type amongst the plurality of resource consumers.

17. A host system, comprising:
resources comprising compute resources, the compute resources comprising at least one computer processor;
a resource allocator operatively connected to the resources and executing on the at least one computer processor; and
a plurality of resource consumers operatively connected to the resource allocator and also executing on the at least one computer processor,
wherein the resource allocator is configured to perform a method for resource allocation optimization, the method comprising:
selecting a resource type from the resources;
computing, based on the resource type, a plurality of weights comprising a weight for each resource consumer of the plurality of resource consumers;
computing, of the resource type, a total resource usage based on the plurality of weights and a division of available resource type units;
making a determination that the total resource usage equals one; and
allocating, based on the determination, a number of available resource type units of the resource type amongst the plurality of resource consumers.

18. The host system of claim 17, wherein the resources further comprises memory resources, storage resources, networking resources, and accelerated compute resources, and wherein the resource type is one of the compute resources, the memory resources, the storage resources, the networking resources, and the accelerated compute resources.

19. The host system of claim 17, wherein the host system is a computing device.

20. The host system of claim 17, wherein the host system is a hyper-converged infrastructure (HCI) cluster.
